(19) United States
(12) Patent Application Publication
(10) Pub. No.: US 2021/0216185 A1
(43) Pub. Date: Jul. 15, 2021

(54) ELECTRONIC PENS WITH SENSORS COUPLED TO COMMUNICATIVE TIPS

(71) Applicant: HEWLETT-PACKARD DEVELOPMENT COMPANY, L.P., Spring, TX (US)

(72) Inventors: Sara R. FERRIS, Houston, TX (US); Dimitre D. MEHANDJIYSKY, Houston, TX (US); Manjunath BHAT, Houston, TX (US)

(73) Assignee: HEWLETT-PACKARD DEVELOPMENT COMPANY, L.P., Houston, TX (US)

(21) Appl. No.: 16/076,078

(22) PCT Filed: Jul. 7, 2017
(86) PCT No.: PCT/US2017/041213

§ 371 Date: Aug. 7, 2018

(51) Int. Cl. G06F 3/041; G06F 3/0354; G06K 9/22; G06K 9/00

(52) U.S. Cl. CPC G06F 3/04162; G06F 3/03545; G06K 9/00416; G06K 9/222; G06F 3/0414

(57) ABSTRACT

An electronic pen is discussed herein that has a body portion extending from a first side to a second side along a central axis, wherein the body portion comprises a non-transitory memory, an antenna, and a battery. A writing tip is coupled to the first side of the body portion and a first sensor electrically coupled to the writing tip to communicate with the writing tip. The electronic pen has a compressible tip coupled to the second side of the body portion and a second sensor in communication with the compressible tip to respond to compression of the compressible tip.

### BACKGROUND

Interactive display boards may be fabricated in the form of whiteboards and may be of varying sizes and shapes, from those that are handheld to those that span entire walls of classrooms and conference rooms. The interactivity with these boards may come in the form of peripheral devices including companion accessories that interact directly with the whiteboards, such as styluses, and may also come in the form of user-owned peripheral devices such as laptops, desktops, mobile communication devices, tablets, and personal digital assistants. The interactive whiteboards may be configured to communicate with both companion accessories as well as user-owned equipment.

### BRIEF DESCRIPTION OF THE DRAWINGS

Various examples will be described below referring to the following figures:

FIG. 1 is a flow chart of a method of using an electronic pen according to certain examples of the present disclosure;

FIG. 2 is a flow chart of a method of using an electronic pen according to certain examples of the present disclosure;

FIGS. 3A-3B are partial schematic cross-sections of a compressible tip in each of a compressed and an uncompressed state, according to certain examples of the present disclosure;

FIG. 4A is a partial schematic cross-section of an electronic pen according to certain examples of the present disclosure;

FIG. 4B is a partial schematic of an interactive surface according to certain examples of the present disclosure;

FIGS. 5A-5I are partial schematic side views of various writing tip configurations according to certain examples of the present disclosure;

FIGS. 6A-6D are partial schematic side views of the compressible tip according to certain examples of the present disclosure; and

FIGS. 7A-70 are schematic illustrations of display options presented to an electronic pen according to certain examples of the present disclosure.

### DETAILED DESCRIPTION

Current interactive board technologies, including virtual whiteboards, may employ peripheral devices that enable users to choose various writing preferences by interacting with a predetermined area of the interactive surface. As discussed herein, an “interactive surface” comprises any substrate or combination of substrates capable of communicating with peripheral devices to display markings resulting from the communication between the surface and the peripheral device. This is in contrast to a conventional writing surface, such as paper, a whiteboard, or a blackboard, where the markings may be left by a peripheral device such as a marker or piece of chalk. As used herein, the term “markings” may be used to collectively describe freehand-originated features such as text, drawings, stamps, images, and typeface text that may be imported from peripheral devices, as well as combinations thereof. Thus, a marking would include an image imported to an interactive surface that is then modified by, for example, freehanded writing to emphasize, modify, or deemphasize various features of the image.

Some interactive boards and surfaces may be larger than a person's arm span, with some boards extending an entire length and/or height of a wall. Since the walls containing the interactive surfaces may comprise at least one dimension greater than 30 feet, the user of the board may have to interrupt her presentation or lecture to travel across a room to perform various functions. This may be because the interactive surfaces have designated areas where peripheral devices, such as e-pens, may be used. That is, the user cannot smoothly transition between writing styles, colors, importing/exporting, and other interactive surface functions unless they are interacting with a predetermined portion of the interactive surface that is less than the entire surface and often located at an end portion of the surface. In addition, conventional interactive surfaces may require log-in credentials and/or time-consuming transition processes among and between users. The peripheral devices, such as electronic pens, may be configured to work on tablets and other devices where the user is writing at an upright angle or perpendicular to a surface, as opposed to on a whiteboard where the user may prefer to write at an angle other than perpendicular to the surface.

At least some of the systems and methods discussed herein are directed toward an electronic pen, which may be referred to herein as “the pen” or as an “e-pen.” In some examples, the electronic pen comprises a first side, a second side, and a body portion extending between the two sides. Each of the first and second sides may comprise a “communicable tip” capable of receiving and transmitting information to and from interactive surfaces and other peripheral devices. The first side of the e-pen comprises a pliable tip that may be referred to as the “front of the pen,” the “front tip,” or the “writing tip,” since its interaction with the interactive surface may generate a plurality of markings. The writing tip may be made from materials similar to those used for markers on non-electronic whiteboards, such as felt, cotton, or another textile, and the writing tip may include a polymer core for flexibility. The writing tip is electrically and mechanically coupled to a plurality of sensors and provides users with a writing experience that is closer to the tactile feel, and therefore easier to use, than previously employed pens that may be hard-tipped styluses or that may be designed to function at a limited range of angles with respect to the interactive surface.

In various examples, the writing tip at the front of the pen may take various forms and cross-sectional shapes, including domes, triangles, angled tips, blunt tips, trapezoidal tips, and combinations thereof, The writing tip communicates with the electronic whiteboard or other interactive surface to create a plurality of markings of different dimensions and colors on the interactive surface. In some examples, the writing tip may also be employed for editing functions such as selection, copying, cutting, pasting, rotation, sizing, and cropping of text and drawings. In various examples, the writing tip may be used to write original text on the interactive surface in various colors and line thicknesses, as well as edit others' text that was previously drawn and/or imported, draw figures, edit charts/graphs, and mark up documents that may be loaded onto the interactive surface, These documents may be imported onto the interactive surface from a memory in the interactive surface and/or from remote servers, and may comprise portable document format (PDF) files, plain text files, word processing files, charts, graphs, spreadsheets, video files, or other document types. In some examples, hand-written text on the interactive surface may be converted to a font style based on user selection or predetermined preferences.

The second side of the e-pen, which may also be referred to as the back of the e-pen, may comprise a compressible tip. The compressible tip may be fabricated from a polymer and may encase a sensor and/or a plurality of controls. When pressure is applied to the back of the e-pen via the compressible tip—for example, when compressed against an interactive surface such as an electronic whiteboard—a menu with selectable options is displayed on the interactive surface. This menu may be displayed in the location where the compressible tip is in contact with the interactive surface, and may present as (1) a pull-down menu originating from the compressible tip or in proximity to the compressible tip, (2) a circular, semi-circular, elliptical, or semi-elliptical menu arranged around the compressible tip for 180, 270, or 360 degrees, or (3) other configurations as further discussed below.

As discussed herein, “selectable options” include both those options for markings such as the color, font (if font conversion from handwriting is available), line size (thickness), and line style (e.g., rounded/blunt ends of text), as well as graphics options such as insertion/importing/uploading and/or editing of geometric shapes or flow chart elements, video, and still images. In some examples, the selectable options presented when pressure is applied to the compressible tip include editing options including selecting, copying, pasting, cutting, rotation, cropping, and sizing. Depending upon the example, some or all of these selectable options may be presented to the user when pressure is applied to the compressible tip in and/or around the location where the compressible tip is in contact with the interactive surface. The user may rotate, slide, move, or otherwise use the compressible tip to select an option from the displayed menu. If an option is selected such that it is changed from an initial setting, the user may save this option in an existing pen or user profile or may create a new pen or user profile. Decompressing the compressible tip may remove the display options regardless of whether or not an option was selected. In some examples, the selectable options may be in the form of categories, where the categories are color, line width, editing, or insertion, and the respective sub-categories (options) may be selected after the categories are selected. In contrast to other designs, the user may apply pressure to the compressible tip and pull up the selectable options menu(s) anywhere on the interactive surface, and therefore does not have to leave a location where he/she is already engaged with the interactive surface in order to change a writing characteristic such as a font color, style, or line thickness or style, nor to select an editing option.

Turning to the initial activation of the e-pen, in some examples, the e-pen comprises a non-transitory memory that stores a plurality of default settings for the e-pen, including a default color and line width and/or style. A line style may include the style of the ends of the line (e.g., rounded, square, angled), and/or whether the line is solid, dashed, dotted, and/or banded. When an e-pen is activated (e.g., powered on), for example, by self-activation that is automatic in response to a sensor of the e-pen detecting a predetermined proximity of the e-pen to the interactive surface (e.g., via radio frequency sensors in the writing and/or compressible tips and the interactive surface), this default profile may load, and options may be changed, as discussed above, using the compressible tip. In some examples, the non-transitory memory of the e-pen and/or of the interactive surface may store a plurality of user profiles. The e-pen may comprise an active portion on the body portion that receives a biometric input, such as a fingerprint, voice input, or ocular scan. An application on the e-pen would then either compare the biometric input to a plurality of stored profiles on the e-pen or transmit the biometric input to a remote application. This remote application may be stored on or otherwise associated with the interactive surface and may be executed by a processor located, e.g., in the interactive surface. In either example, a processor executing the application (either on the e-pen or in a remote location) compares the biometric input to a plurality of stored profiles. If the application determines that there is a profile associated with the biometric input, that profile is loaded onto and/or transmitted (e.g., via radio frequency communications) to the e-pen and/or the interactive surface such that markings made while the profile is loaded comprise the properties of that profile. The profiles may be added to expand the settings to include, for example, other settings available as selectable options. In some examples, a user can power-off the e-pen and automatically unload their profile. In another example, when a first profile associated with a first biometric input is loaded on an e-pen and the e-pen receives a second, different biometric input, a secondary confirmation may be requested by the e-pen processor prior to switching to a second profile that is associated with the second biometric input. This secondary confirmation may comprise, e.g., repeating the second biometric input and/or creating a predetermined marking using the e-pen.

The e-pen discussed herein may be used with various interactive surfaces for a smoother user experience, due to a combination of at least the pliable writing tip that creates the tactile feel of using a marker, the ability of the compressible tip to retrieve a menu of selectable options anywhere on an interactive surface, and the use of biometric inputs to link profiles to users to further enhance, ease, and customize the user experience.

In accordance with an example of the present disclosure, an electronic pen is provided. In this example, the electric pen comprises: a body portion extending from a first side to a second side along a central axis, wherein the body portion comprises: a non-transitory memory; an antenna; and a battery. In this example, the electronic pen may further comprise: a writing tip coupled to the first side of the body portion; a first sensor electrically coupled to the writing tip to communicate with the writing tip; a compressible tip coupled to the second side of the body portion; a second sensor in communication with the compressible tip to respond to compression of the compressible tip, wherein a cross-section of the writing tip comprises a polygon, a triangle, a dome, or combinations thereof. Further in this example, the antenna communicates via at least one of Bluetooth, near-field communication (NFC), or Wi-Fi, and the writing tip is a writing tip formed from a pliable material comprising foam, felt, polymer, cotton, or combinations thereof. In this example, the compressible tip, when configured in a compressed state, selects at least one option from a plurality of selectable options comprising writing options, editing options, and graphics options, wherein the plurality of selectable options are displayed on an interactive surface in communication with the compressible tip in response to the compressed state. Furthermore in this example electronic pen, the electronic pen comprises: a biometric sensor coupled to the body portion, wherein the non-transitory memory stores a plurality of profiles, wherein each profile of the plurality of profiles is associated with a biometric signature obtained via the biometric sensor, and a first plurality of controls in communication with the writing tip and a second plurality of controls in communication with the compressible tip and a first plurality of controls in communication with the writing tip and a second plurality of controls in communication with the compressible tip.

In accordance with an example of the present disclosure, an interactive surface system is provided. In this example, the interactive surface system comprises an interactive surface comprising an application stored on a non-transitory memory and executable by a processor; and an electronic pen. In this example, the electronic pen comprises: a body portion extending from a first side to a second side along a central axis, wherein the body portion comprises: a non-transitory memory; an antenna; a battery; a writing tip coupled to the first side; a first sensor electrically coupled to the writing tip to communicate with the writing tip; a compressible tip coupled to the second side; and a second sensor to respond to compression of the compressible tip. In the example interactive surface system, when the electronic pen is configured in a first state, the compressible sensor is compressed via pressurized contact in a first location on the interactive surface, wherein, in response to the compression of the compressible sensor, a plurality of selectable options are displayed on the interactive surface in proximity to the first location, wherein the plurality of selectable options comprise writing options, editing options, and graphics options, Further in this example, the interactive surface system comprises a biometric sensor coupled to the body portion, wherein the non-transitory memory stores a plurality of profiles, wherein each profile of the plurality of profiles is associated with a biometric signature obtained via the biometric sensor.

In accordance with an example of the present disclosure, a method of using an electronic pen. In this example, the method comprises: applying pressure to a first side of an electronic pen, wherein the first side comprises a compressible tip and a second side of the electronic pen comprises a writing tip, wherein the electronic pen is associated with a first profile comprising a first set of writing properties; compressing, in response to applying pressure, the compressible tip against an interactive surface; selecting, via a motion of the compressible tip of the electronic pen, at least one option of a plurality of selectable options displayed on the interactive surface subsequent to the compressing; and changing, in response to the selecting, at least one writing property of the first set of writing properties from an initial state of the first profile to a different state based on the selected option. Further in this example, the method comprises: loading, prior to the applying pressure to the first side, the first profile in response to a biometric input received via a biometric sensor coupled to the electronic pen, based on a previously stored association between the biometric input and the first profile; subsequent to changing the at least one writing property, saving, via a second motion of the compressible tip, the different state of the at least one writing property in the first profile; subsequent to changing the at least one writing property, reapplying pressure to the compressible tip and decompressing the sensor; and drawing, by applying pressure between the writing tip and the interactive surface, a plurality of writings on the electronic whiteboard, wherein the plurality of writings are associated with the different state of the at least one writing property.

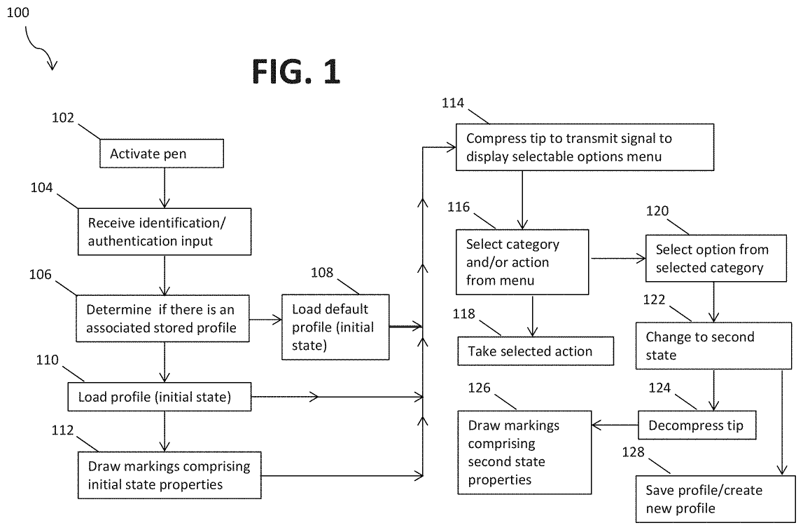

FIG. 1 is a flow chart of a method 100 of using an electronic pen according to certain examples of the present disclosure. Some portions of FIG. 1 show two possible outputs from a single block. In such instances, the two outputs comprise alternative, example courses of action. In the method 100 at block 102, the pen may be powered on and activated. This powering on and activation may occur through the physical activation of a button or switch on the pen, through a voice command, via a proximity sensor that detects that the e-pen is within a predetermined distance of an interactive surface, or through biometric inputs to the pen. At block 104, if a biometric input is not used at block 102, another type of identification and/or authentication input may be employed, such as a predetermined marking made with the e-pen.

The input received at block 104 may be received by a processor executing an application stored in the non-transitory memory of the pen and employed at block 106 to determine if there is a profile stored on the non-transitory memory of the pen that corresponds to the input. In some examples, if no profile is found, a default profile is loaded by the pen at block 108. This default profile may be referred to as the initial state or initial profile of the pen. In another example, if a profile is found at block 106 that corresponds to the input, that profile is loaded at block 110 and this is also referred to as an initial state or initial profile. In some examples, at block 112, a plurality of markings may be drawn on an interactive surface using the writing tip of the pen. These markings comprise properties associated with the initial profile loaded onto the pen. In some examples, this initial profile comprises a blue color and a medium line thickness.

In an example, at block 114, subsequent to the initial profile being loaded at either of blocks 108 or 110, and in some examples after the plurality of markings are drawn at block 112, the application transmits a signal to the interactive surface. This signal is transmitted by the e-pen application when the compressible tip is compressed against the interactive surface, and, subsequently, in response to receiving the signal, a plurality of selectable options are displayed in proximity to the area on the interactive surface where the compressible tip is compressed at block 114. The compression of the compressible tip at block 114 activates a sensor inside of and encased by the compressible portion of the compressible tip. The sensor communicates with a processor executing an application associated with and/or stored on a memory of the interactive surface which displays the menu in response to receiving the signal. At block 116, the pen—for example, the compressible tip end of the pen—may be used to select an option such as a category (e.g., color, line size) or an action (e.g., cut, paste) from the selectable options. This selection may be performed by rotating the compressible tip clockwise or counterclockwise while applying pressure to the compressible tip, or by dragging the compressible tip along the interactive surface to contact a portion of a selectable option. In some examples, selecting a first option at block 116 causes a plurality of sub-options to be displayed, and a sub-option may be selected in the same or a different fashion than the first option was selected. In an example, at block 118, the action selected at block 116 is performed. For example, if an action such as copying is selected at block 116, the area of the interactive surface to be copied is selected at block 118.

In an example, if a category is selected at block 116, an option within that category (e.g., the category selected is “color” and the option selected is “purple”) is selected using the compressible end of the pen (block 120). At block 122, the selected option is changed to the second state (e.g., from the initial state of blue to the second state of purple). At block 128, in some examples, this change from blue to purple may be saved to the profile loaded at block 110 if a profile was loaded at block 110. In alternate examples, at block 128, a new profile may be created and stored using the second state color in addition to the other initial state properties. The updating and/or creation of profiles at block 128 may also be initiated via the compressible tip while the sensor is compressed, and “create new profile” or “store to loaded profile” may be selectable options in some displayed menus. At block 124, the compressible tip may be decompressed against the interactive surface. Subsequently, at block 126, a second plurality of markings may be drawn using the second state properties (e.g., the purple color), regardless of whether the second state has been stored as a part of an existing or new profile at block 128.

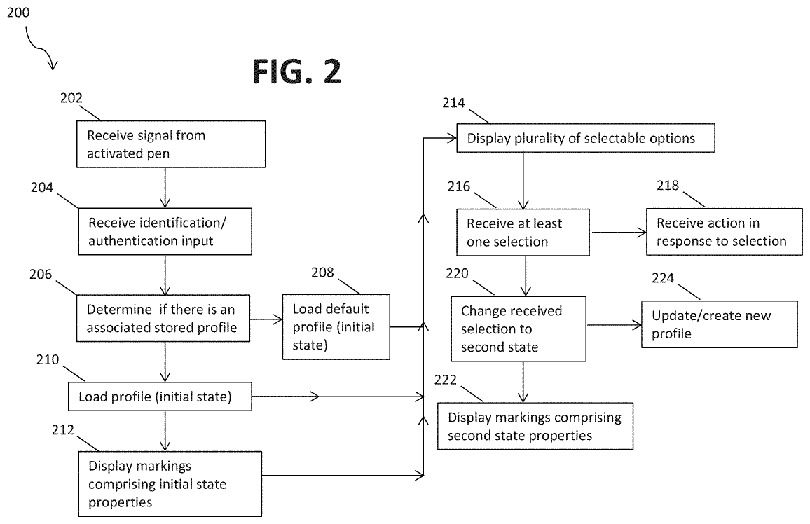

FIG. 2 is a flow chart of a method 200 of using an electronic pen according to certain examples of the present disclosure. In the method 200, at block 202, a processor executing an application stored in a non-transitory memory of an interactive surface receives a signal from an activated electronic pen. At block 204, the interactive surface receives an authentication input from the pen, which may be a biometric input or a drawn input (e.g., drawn on the interactive surface). This input at block 204 may be transmitted by the pen and received by a processor executing an application stored in the non-transitory memory of the interactive surface, At block 206, the processor executing the application stored in the interactive surface determines if there is a stored profile that corresponds to the input from block 204. In some examples, when no profile is found, a default profile is transmitted to the e-pen by the interactive surface's processor (e.g., via a radio frequency signal) and loaded on the pen at block 208. This default profile may be referred to as the initial state or initial profile of the pen.

In another example, when a profile is found at block 206 that corresponds to the input, that profile is loaded onto the pen at block 210. The state of the pen, once the profile is loaded, is also referred to as an initial state or initial profile. At block 212, subsequent to loading an initial state onto the pen at either of blocks 208 or 210, the interactive surface receives a plurality of inputs from the pen and displays a plurality of initial markings comprising properties associated with the initial state. At block 214, the interactive surface receives a signal due to compression of the back of the e-pen against the interactive surface and displays, in response to receiving the signal, a plurality of selectable options within a predetermined proximity to the compressible tip and in a prearranged order with respect to the compressible tip. This prearranged order may comprise a circular, semi-circular, elliptical, or semi-elliptical arrangement in 180, 270, or 360 degrees around the compressible tip, or it may comprise an arrangement of selectable options extending outward from the compressible tip in at least one direction (linearly).

At block 216, a processor executing the application in the interactive surface receives at least one selection from the pen. At block 218, when the at least one selection at block 216 comprises an editing action, the at least one editing action is received from the pen by the processor in the interactive surface. At block 220, when the at least one selection at block 216 comprises a category, the processor in the interactive surface receives at least one selection for a second state of a category and/or sub-category, e.g., if an initial profile comprises green color and thick line style, the change received at block 220 may comprise periwinkle color. At block 224, the processor in the whiteboard receives an input to store the change as either an update to the initial state (profile) or as a new profile. At block 222, regardless of whether the change is saved at block 224 to a new or existing profile, the interactive surface may receive a second plurality of markings via the front end (writing tip). The form and appearance of the second plurality of markings comprises the change received at block 220. Thus, the second plurality of markings at block 222 would comprise periwinkle ink and a thick line style. That is, a selectable option can be selected and used without being saved to a new or existing profile.

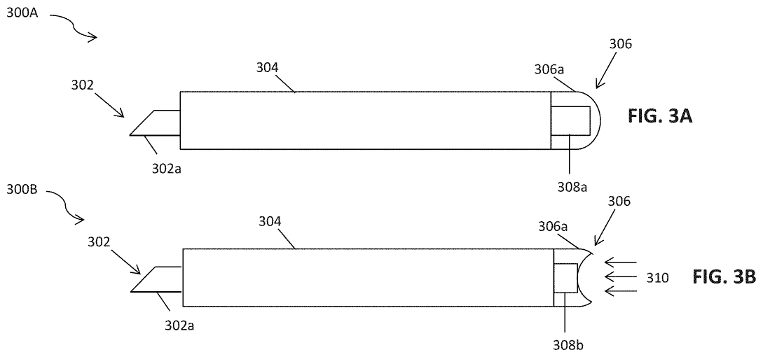

FIGS. 3A-3B are partial schematic cross-sections of an example compressible tip in each of a compressed and an uncompressed state. In particular, FIG. 3A shows an example electronic pen 300A comprising a first side 302 that comprises a pliable tip 302a, which may also be referred to as the writing tip 302a. The writing tip 302a on the first side 302 is coupled to a body portion 304 and a compressible tip 306a is coupled to a second side 306 of the body portion 304. The compressible tip 306a comprises a sensor configured in a first inactivated state 308a. When a compressive force 310 is applied to the compressible tip 306a as shown in FIG. 3B, the sensor is changed to be configured in a second, activated, and compressed state 308b. Thus, FIG. 3B shows an example electronic pen 3006 with the compressible tip 306a in a compressed state 3086. While the compressive force 310 in FIG. 36 is illustrated as being perpendicular to the compressible tip 306, in alternate examples, the compressive force 310 may be applied at other angles and still have the effect of causing the display of a plurality of selectable options on the whiteboard. The writing tip 302 and compressible tip 306a are shown with example geometries in FIGS. 3A and 3B, but alternate geometries are also possible, as discussed in detail below. In alternate examples, the compression visible in FIG. 3B may not be visible to the naked eye; that is, the compression of the compressible tip 306a is a compress-and-release such that the compressible tip 306a returns to its original state 308A when the compressible tip 306a is active (e.g., when the compressible tip 306a is compressed). The compressible tip is compressed again and released to deactivate the compressible tip 306.

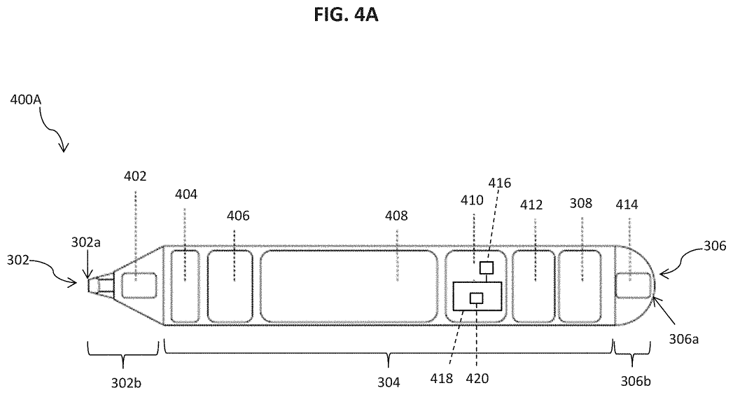

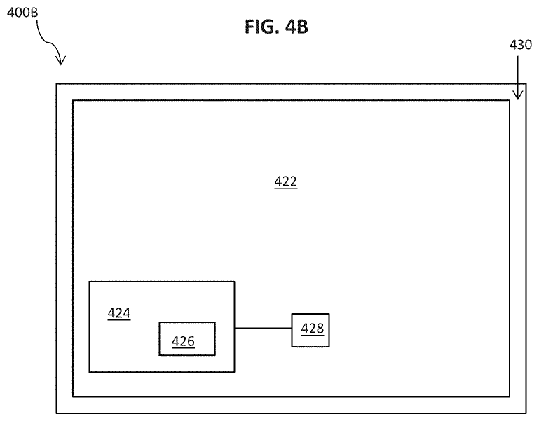

FIG. 4A is a partial schematic cross-section of an example electronic pen 400A. In the cross-section of the e-pen 400A, the first side 302 comprises the first side portion 302b housing the writing tip 302a and a first plurality of controls 402. The writing tip 302a is electrically and physically coupled to the first plurality of controls 402. At least one first side sensor 404 may be disposed in the body 304, as may a biometric sensor 406, a rechargeable battery 408, a printed circuit board (PCB) 410, and an at least one communication component 412. The PCB 410 may comprise a processor 416 that executes an application 420 stored in a non-transitory memory 418 of the PCB 410. While the first plurality of controls 402 is illustrated in FIG. 4A as being in the first side portion 302b, in alternate examples, its position may be switched with the at least one first side sensors 404 such that the first side sensor 404 receives a signal from the writing tip 302a, and is electrically and/or mechanically coupled to the first plurality of controls 402 which may be in communication with other components such that the signals transmitted by the writing tip 302a are ultimately represented as a plurality of markings on an interactive surface (not shown). The various components of the electronic pen may be coupled to each other, either directly or indirectly, to achieve the functionality attributed herein to the electronic pen.

In some examples, a second side sensor 308 is electrically and/or mechanically coupled to the compressible tip 306a, and a plurality of secondary controls 414 are disposed in the compressible tip 306a in the portion 306b located at the second side 306. In this example, the plurality of secondary controls 414 are electrically and/or mechanically coupled to the second side sensor 308 and transmit a signal to the sensor 308 when the compressible tip 306a is compressed as discussed in FIGS. 3A and 3B. While the second side sensor 308 is shown as being located within the body 304, in some examples, as shown in FIGS. 3A and 3B, the second side sensor 308 may be located in the second side portion 306b. In that example, the plurality of secondary controls 414 may be located adjacent to the at least one communication component 412, which may comprise an antenna. In various examples, the second side sensor 308 may comprise a pressure, temperature, level, or a combination of sensors that communicate with components of the e-pen as well as those of an interactive surface such as in FIG. 4B, discussed below,

The rechargeable battery 408 powers the e-pen's functions and components, such as the first side sensor 404, the biometric sensor 406, the second side sensor 308, the pluralities of controls 402 and 414. In some examples, the first plurality of controls 402 is powered by the battery 408 and receives and processes signals such as pressure (e.g., using a pressure sensor) and angle signals (e.g., using an accelerometer, a gyroscope, or a combination thereof) from the writing tip 302a, where the angle is the relative position of the writing tip 302a with respect to an interactive surface. The signals received by the first plurality of controls 402 from the writing tip 302a may be transmitted to the first side sensor 404. The first side sensor 404 communicates with a processor executing at least one application in an electronic whiteboard or other interactive surface (not shown) to transform the motion of the writing tip 302a of the e-pen 400 to markings on the interactive surface that are drawn according to a profile that is active and loaded on the e-pen 400 and/or the whiteboard. In another example, a plurality of sensors such as a proximity sensor, touch sensor, and a plurality of active pen technology logic may be stored in either the first side 302, the second side 306, or the body portion 304, for example, as a part of the secondary controls 414.

The second plurality of controls 414 may be powered by the battery 408 and configured to communicate with components of the e-pen 400A as well as an interactive surface as discussed below in FIG. 4A. The biometric sensor 406 may receive biometric inputs and the secondary controls 414 may transmit the biometric inputs to the whiteboard and/or to compare the input(s) to profiles stored on the pen or the whiteboard, depending upon the system configuration. The at least one communication component 412 facilitates communications between the pen and an interactive surface and may comprise an antenna such as a near-field communication (NFC) or other antenna and/or a module providing at least one of Bluetooth and Wi-Fi capabilities.

FIG. 4B is a partial schematic of an interactive surface device 400B according to certain examples of the present disclosure. The interactive surface 400B may comprise a border region 430 that may be enabled to interact with a plurality of peripheral devices via the components discussed herein, or which may be a non-functional region 430 employed for cosmetic purposes. The interactive surface 400B also comprises a functional surface region 422 where a plurality of operations such as the writing of markings by a writing tip and/or the display of a menu using a compressible tip as discussed herein. The plurality of operations executed via the functional surface 422 may be responsive to a device such as the e-pen 400A in FIG. 4A and may be executed via an application 426 stored in a non-transitory memory 424 of the interactive surface device 400B when the application 426 is executed by a processor 428 of the interactive surface device 400B.

In one example, referring to FIG. 4A as well as FIG. 4B, the pluralities of controls 402 and 414 of the e-pen 400A communicate (transmit information to and/or receive information from) via the application 420 with an application 426 stored in a non-transitory memory 424 of the interactive surface device 400B that is executed by a processor 428. In one example, the functional surface region 422 displays a plurality of markings in response to information transmitted between the compressible tip 302a and its associated sensor 404 and controls 402 with the application 426 via the e-pen 400A application 420. In another example, the functional surface region 422 displays a menu of selectable options and enables the selection of one or more options in response to communications between the compressible tip 306a and its associated sensor 308 and controls 414 with the application 426 via the e-pen 400A application 420.

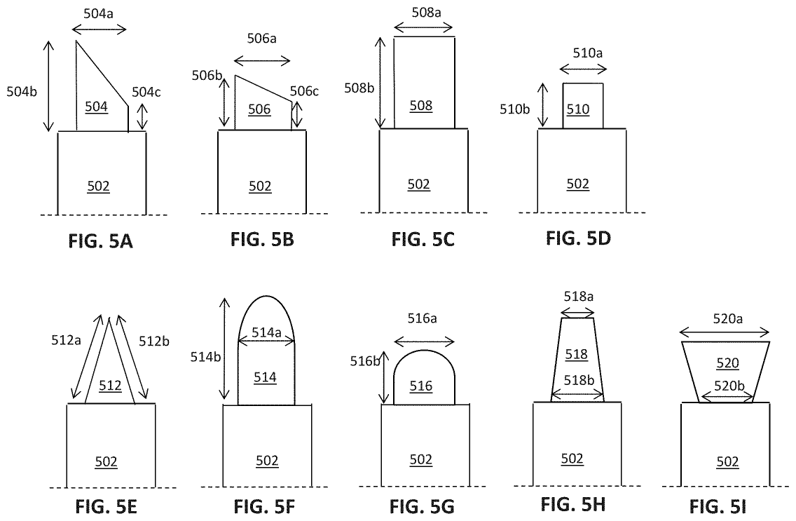

FIGS. 5A-5I are partial schematic side views of various writing tip configurations according to certain examples of the present disclosure. Each of FIGS. 5A-5I shows a partial body 502 of an electronic pen, as well as a different writing tip geometry. The relative dimensions of the writing tips to the body 502 may vary among and between examples.

FIGS. 5A and 5B illustrate angled writing tips 504 and 506. The angled writing tip 504 in FIG. 5A comprises a first height 504b, a second height 504c, and a width 504a. The angled writing tip 506 in FIG. 5B comprises a first height 506b which may be less than 504b, a second height 506c which may be substantially similar (i.e., within 10% of) the second height 504c, and a width 506a, which may be greater than the width 504a of the writing tip 504 in FIG. 5A.

FIGS. 5C and 5D illustrate blunt writing tips 508 and 510. The blunt writing tip 508 in FIG. 50 comprises a height 508b and a width 508a, and the blunt writing tip 510 in FIG. 5D comprises a height 510b and a width 510a, both of which are smaller than the height 508b and width 508a of the blunt writing tip 508 in FIG. 5C.

FIG. 5E illustrates a triangular writing tip 512. The triangular tip 512 may comprise a circular or polygonal base leading to a generally cone-shaped geometry. In the case of a polygonal base, the writing tip 512 comprises sides of equal length 512a and 512b. FIGS. 5F and 5G illustrate domed writing tip geometries 514 and 516. The domed writing tips 514 and 516 may have different radii of curvature. FIG. 5F comprises a tip 514 with a height 514b and a width 514a of the body (e.g., not the domed feature, which tapers as illustrated to form a rounded tip 514). FIG. 5G shows a writing tip 516 comprising a height 516b that is less than the height 514b of the writing tip 514 in FIG. 5F and a width 516a that is greater than the width 514a of the writing tip 514.

FIGS. 5H and 51 illustrate trapezoidal writing tip configurations 518 and 520, respectively. In FIG. 5H, the trapezoidal tip 518 comprises a taper such that a first width 518b is greater than a second width 518a. FIG. 5I, the writing tip 520 comprises a taper such that a first width 520b that is less than a second width 520a.

Each of the writing tips shown in FIGS. 5A-5I also comprises a thickness along an axis not shown as these are side view schematics. The thicknesses of the writing tips may range from 0.1 inches to 0.33 inches or more, depending upon the example. In some examples, such as the triangular tip 512 of FIG. 5E, discussed below, a dimension including the thickness may taper such that the thickness decreases further from the body 502. In alternate examples, such as the trapezoidal writing tip 520 of FIG. 5I, the thickness may taper such that it increases further from the body 502. While physical tip configurations are shown in FIGS. 5A-51, in some examples, a selectable option discussed herein may comprise a writing tip geometry, such that a physical writing tip geometry of one type—for example, the angled tip 504 of FIG. 5A—may be able to draw a finer point line as if it were a triangle tip 512 of FIG. 5E or another style of line that does not correspond to the actual physical geometry of the writing tip.

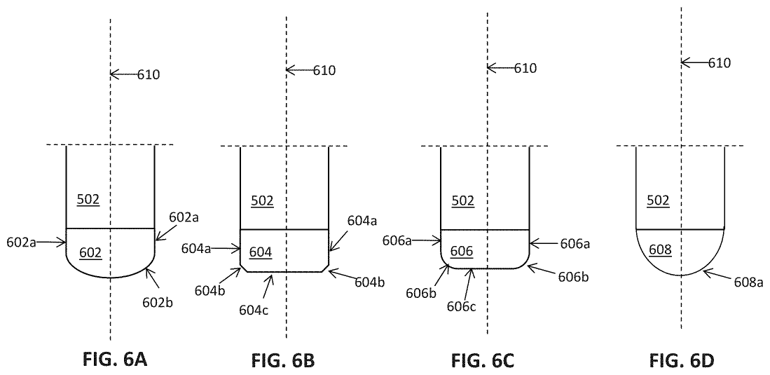

FIGS. 6A-6D are partial schematic side views of the compressible tip according to certain examples of the present disclosure. Each of FIGS. 6A-6D shows a partial electronic pen body 502. FIG. 6A shows a tip 602 comprising portions 602a extending outward parallel to a central axis 610 along which the body is aligned. The compressible tip 602 comprises a rounded portion 602b extending from and connecting the parallel portions 602a. FIG. 6B shows a tip 604 comprising portions 604a extending outward from the body 502 parallel to the central axis 610, and two angled portions 604b that connect each portion 604a to a flat end 604c that is perpendicular to the central axis 610. FIG. 6C shows a tip 606 comprising portions 606a extending from the body 502 parallel to the central axis 610, rounded portions 606b extending from the parallel portions 606a to the flat portion 606c that is perpendicular to the central axis 610. FIG. 6D comprises a tip 608 that has a domed cross-section and is defined by a smoothly curved surface 608a.

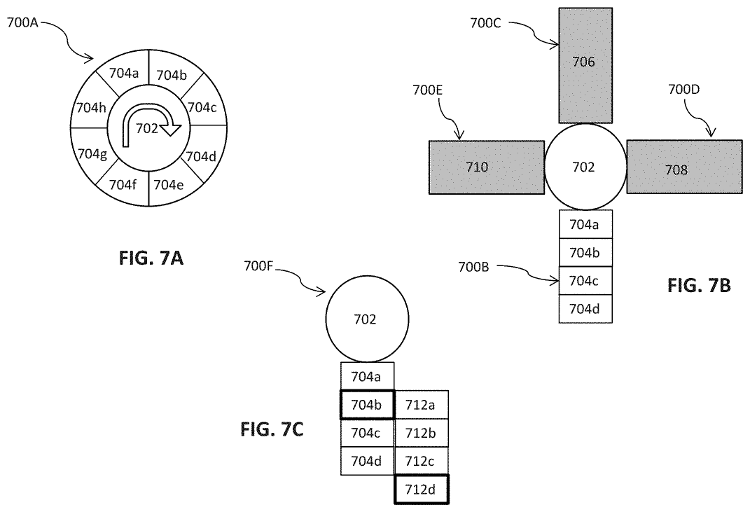

FIGS. 7A-7C are schematic illustrations of display options presented to an electronic pen according to certain examples of the present disclosure. FIG. 7A shows example display 700A. In this example, the electronic pen is compressed in the target area 702, in response to which a circle of selectable options 704a-704h is displayed. These selectable options 704a-704h may comprise categories such as colors and/or line thicknesses, as well as editing options, as discussed above. In some examples, the pen may be rotated as indicated by the arrow in order to select an option. In alternate examples, the pen may be rotated in the opposite direction of the arrow, and in still other examples, the pen may be moved, that is, dragged (continuous contact with the interactive surface) or swiped (non-continuous contact with the interactive surface) to be in contact with a portion of one of the selectable options 704a-704h in order to select that option. In some examples, sub-categories/options may also be available. These may be displayed in a similar arrangement to the selectable options 704a-704h. The target area 702 may be located anywhere on an electronic whiteboard or interactive surface. It is defined herein as a “target” to provide context for the proximity and/or arrangement of displayed selectable options and not to imply that one area of the whiteboard or surface is preferred over another, or that a particular portion of the whiteboard or surface must be used to generate the display. That is, the target area 702 is any area on an interactive surface where the compressible tip discussed above is compressed, and it is used to describe an origin point from which or at which the selectable options discussed herein are displayed.

FIG. 7B shows an alternate configuration of an example display. In this example, the electronic pen is also compressed in the target area 702, which may cause a plurality of selectable options to appear in one or more of zones 700B, 700C, 7000, and/or 700E, or in other zones extending outward at other angles from the target area 702. As shown in the example zone 700B, a plurality of selectable options 704a-704d (or more) may be displayed in response to compression of the pen in the target area 702.

As shown in FIG. 7C in the example display 700F, an option such as 704b may be selected from the displayed menu, and that selection may trigger a second menu comprising selectable options 712a-712d to be displayed. If 712d, for example, is selected, this may reset that option on the profile, or at least in the active pen session which is maintained until the option is again changed or until the pen is deactivated. As used herein, the deactivation of the pen may comprise turning the pen off or changing profiles. For example, if option 704b is a color category, then options 712a-712d may comprise different colors. If 712d is purple and is selected, the writing tip would then generate purple markings until the selectable option is again changed.

The above discussion is meant to be illustrative of the principles and various examples of the present disclosure. Numerous variations and modifications of the foregoing examples are contemplated. It is intended that the following claims be interpreted to embrace all such variations and modifications.

What is claimed is:

1. An electronic pen, comprising:
a body portion extending from a first side to a second side along a central axis, wherein the body portion comprises:
a non-transitory memory;
an antenna; and
a battery;
a writing tip coupled to the first side of the body portion;
a first sensor electrically coupled to the writing tip to communicate with the writing tip;
a compressible tip coupled to the second side of the body portion; and
a second sensor in communication with the compressible tip to respond to compression of the compressible tip.

2. The electronic pen of claim 1, wherein the antenna communicates via at least one of Bluetooth, near-field communication (NFC), or Wi-Fi.

3. The electronic pen of claim 1, wherein the writing tip is a writing tip formed from a pliable material comprising foam, felt, polymer, cotton, or combinations thereof.

4. The electronic pen in claim 1, wherein the compressible tip, when configured in a compressed state, selects at least one option from a plurality of selectable options comprising writing options, editing options, and graphics options, wherein the plurality of selectable options are displayed on an interactive surface in communication with the compressible tip in response to the compressed state.

5. The electronic pen of claim 1, further comprising a biometric sensor coupled to the body portion, wherein the non-transitory memory stores a plurality of profiles, wherein each profile of the plurality of profiles is associated with a biometric signature obtained via the biometric sensor.

6. The electronic pen of claim 1, wherein a cross-section of the writing tip comprises a polygon, a triangle, a dome, or combinations thereof.

7. The electronic pen of claim 1, further comprising a first plurality of controls in communication with the writing tip and a second plurality of controls in communication with the compressible tip.

8. An interactive surface system, comprising:
an interactive surface comprising an application stored on a non-transitory memory and executable by a processor; and
an electronic pen comprising:
a body portion extending from a first side to a second side along a central axis, wherein the body portion comprises:
a non-transitory memory;
an antenna;
a battery;
a writing tip coupled to the first side;
a first sensor electrically coupled to the writing tip to communicate with the writing tip;
a compressible tip coupled to the second side: and
a second sensor to respond to compression of the compressible tip.

9. The interactive surface system of claim 8, wherein, when configured in a first state, the compressible sensor is compressed via pressurized contact in a first location on the interactive surface, wherein, in response to the compression of the compressible sensor, a plurality of selectable options are displayed on the interactive surface in proximity to the first location.

10. The interactive surface system in claim 9, wherein the plurality of selectable options comprise writing options, editing options, and graphics options.

11. The interactive surface system of claim 8, further comprising a biometric sensor coupled to the body portion, wherein the non-transitory memory stores a plurality of profiles, wherein each profile of the plurality of profiles is associated with a biometric signature obtained via the biometric sensor.

12. A method, comprising:
applying pressure to a first side of an electronic pen, wherein the first side comprises a compressible tip and a second side of the electronic pen comprises a writing tip, wherein the electronic pen is associated with a first profile comprising a first set of writing properties;
compressing, in response to applying pressure, the compressible tip against an interactive surface;
selecting, via a motion of the compressible tip of the electronic pen, at least one option of a plurality of selectable options displayed on the interactive surface subsequent to the compressing; and
changing, in response to the selecting, at least one writing property of the first set of writing properties from an initial state of the first profile to a different state based on the selected option.

13. The method of claim 12, further comprising loading, prior to the applying pressure to the first side, the first profile in response to a biometric input received via a biometric sensor coupled to the electronic pen, based on a previously stored association between the biometric input and the first profile.

14. The method of claim 12, further comprising, subsequent to changing the at least one writing property, saving, via a second motion of the compressible tip, the different state of the at least one writing property in the first profile.

15. The method of claim 12, further comprising:
subsequent to changing the at least one writing property, reapplying pressure to the compressible tip and decompressing the sensor; and
drawing, by applying pressure between the writing tip and the interactive surface, a plurality of writings on the electronic whiteboard, wherein the plurality of writings are associated with the different state of the at least one writing property.
